(19) United States
(12) Patent Application Publication
(10) Pub. No.: US 2024/0112846 A1
(43) Pub. Date: Apr. 4, 2024

(54) DOUBLE CHOKE CONSTRUCTION FOR LIQUID COOLED POWER MODULE

(71) Applicant: SCHNEIDER ELECTRIC IT CORPORATION, Foxboro, MA (US)

(72) Inventors: Claus Aabjerg Andersen, Kolding (DK); Jonas Sonsby Mouridsen, Odense V (DK); Frederik Christian Behnke, Kolding (DK)

(73) Assignee: SCHNEIDER ELECTRIC IT CORPORATION, Foxboro, MA (US)

(21) Appl. No.: 18/244,953

(22) Filed: Sep. 12, 2023

Related U.S. Application Data
(60) Provisional application No. 63/413,023, filed on Oct. 4, 2022.

(51) Int. Cl. H01F 27/22; H01F 27/00; H01F 27/02; H01F 27/28; H01F 27/30; H01F 27/38

(52) U.S. Cl. CPC H01F 27/22; H01F 27/006; H01F 27/025; H01F 27/2876; H01F 27/306; H01F 27/38; H01F 27/10

(57) ABSTRACT

A multi-transformer assembly includes a first transformer having a first core and a first set of windings, a second transformer having a second core and a second set of windings, and a heatsink positioned between the first core and the second core. The heatsink includes a first side and a second side. The first side of the heatsink is opposite the second side of the heatsink, and thermally coupled to the first core and the first set of windings. The first side is thermally coupled to the first core and the first set of windings by a first thermal conductor. The second side is thermally coupled to the second core and the second set of windings. The second side is thermally coupled to the second core and the second set of windings by a second thermal conductor.

### CROSS-REFERENCE TO RELATED APPLICATION

This application claims the benefit under 35 U.S.C. § 119(e) of co-pending U.S. Provisional Patent Application No. 63/413,023 titled DOUBLE CHOKE CONSTRUCTION FOR LIQUID-COOLED POWER MODULE filed on Oct. 4, 2022, which is incorporated herein by reference in its entirety for all purposes.

### BACKGROUND

### 1. Field of the Disclosure

The present disclosure is directed to power devices, and more particularly to an assembly having cores of transformers thermally coupled to a heatsink.

### 2. Discussion of Related Art

Power devices, such as uninterruptible power supplies, may be used to provide power to one or more loads. Power devices may include power converters, such as DC/DC converters, AC/DC converters, and DC/AC converters. DC/DC converters convert DC power of one voltage level to DC power of another voltage level. DC/AC converters, or “inverters,” convert DC power to AC power. AC/DC converters, or “rectifiers,” convert AC power to DC power.

Managing cooling of power devices can be a challenge. It is desirable to increase power density of the power device as well as higher operating temperature and higher waste temperatures.

### SUMMARY

One aspect of the present disclosure is directed to a multi-transformer assembly, comprising a first transformer comprising a first core and a first set of windings, a second transformer comprising a second core and a second set of windings, and a heatsink positioned between the first core and the second core.

Embodiments of the multi-transformer assembly further may include configuring the heatsink to include a first side and a second side. The first side of the heatsink may be opposite the second side of the heatsink. The first side may be thermally coupled to the first core and the first set of windings. The first side may be thermally coupled to the first core and the first set of windings by a first thermal conductor. The second side may be thermally coupled to the second core and the second set of windings. The second side may be thermally coupled to the second core and the second set of windings by a second thermal conductor. The second side may be thermally coupled to the second core and the second set of windings. The second side may be thermally coupled to the second core and the second set of windings by a second thermal conductor. The first set of windings of the first transformer may include a first primary winding with N1 turns and a first secondary winding with N2 turns, and the second set of windings of the second transformer may include a second primary winding with N3 turns and a second secondary winding with N4 turns. The first primary winding and the second secondary winding may be in series with the first input and an output, and the first secondary winding and the second primary winding may be in series with the second input and the output. The first primary winding and the first secondary winding may be configured to generate in-phase magnetic fields that cancel each other responsive to receiving at least one signal from at least one of the first input or the second input. The second primary winding and the second secondary winding may be configured to generate in-phase magnetic fields that cancel each other responsive to receiving the at least one signal from the at least one of the first input or the second input. A turns ratio of the first transformer may be based on a turns ratio of the second transformer. The heatsink may include at least one plate. The first core of the first transformer and the second core of the second transformer each may include a ferrite core. The multi-transformer assembly further may include a first housing configured to support the first set of windings and the first core of the first transformer and a second housing configured to support the second set of windings and the second core of the second transformer. Each of the first housing and the second housing may be configured to receive a thermal coupling material to secure the first core and the first set of windings of the first transformer to a first side of the heatsink and to secure the second core and the second set of windings of the second transformer to a second side of the heatsink. The first housing may include a first guide to position the first core to the first housing and the second housing includes a second guide to position the second core to the second housing.

Another aspect of the present disclosure is directed to a method of assembling a multi-transformer assembly. In one embodiment, the method comprises: providing a heatsink having a first side and a second side; thermally coupling a first core and a first set of windings of a first transformer to the first side of the heatsink; and thermally coupling a second core and a second set of windings of a second transformer to the second side of the heatsink.

Embodiments of the method further may include securing the first core and the first set of windings of the first transformer to a first housing and securing the second core and the second set of windings of the second transformer to a second housing. A thermal coupling material may be used to secure the first set of windings and the first core of the first transformer to the first housing and to secure the second set of windings and the second core of the second transformer to the second housing. The first side may be thermally coupled to the first core and the first set of windings by a first thermal conductor and the second side may be thermally coupled to the second core and the second set of windings by a second thermal conductor. The first side of the heatsink may be opposite the second side of the heatsink. At least one of the first transformer may be configured to generate in-phase magnetic fields that cancel each other, or the second transformer may be configured to generate in-phase magnetic fields that cancel each other. The first transformer may be a first primary winding and a first secondary winding. The first primary winding and the first secondary winding may be configured to generate in-phase magnetic fields to cancel each other out responsive to the first primary winding and the first secondary winding each receiving a respective signal. The second transformer may include a second primary winding coupled to the first secondary winding and a second secondary winding coupled to the first primary winding. The second primary winding and the second secondary winding may be configured to generate in-phase magnetic fields to cancel each other out responsive to the second primary winding and the second secondary winding each receiving a respective signal. The second transformer may include a primary winding and a secondary winding. The primary winding and the secondary winding may be configured to generate in-phase magnetic fields to cancel each other out responsive to the primary winding and the secondary winding each receiving a respective signal.

Yet another aspect of the present disclosure is directed to a method providing a choke to a power module. In one embodiment, the method comprises: receiving, at a first input, a first signal; providing the first signal to a first primary winding of a first transformer including the first primary winding and a first secondary winding turns; providing the first signal from the first primary winding to a second secondary winding of a second transformer comprising a second primary winding and the second secondary winding; providing the first signal from the second secondary winding to an output; receiving, at a second input, a second signal; providing the second signal to the first secondary winding; providing the second signal from the first secondary winding to the second primary winding; and providing the second signal from the second primary winding to the output. A heatsink is positioned between the first core and the second core, with the heatsink including a first side and a second side, the first side being thermally coupled to the first core and the first set of windings by a first thermal conductor and the second side being thermally coupled to the second core and the second set of windings by a second thermal conductor.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of an uninterruptible power supply according to an example;

FIG. 2 is a side view of a multi-transformer assembly of an embodiment of the present disclosure;

FIG. 3 is a perspective view of the multi-transformer assembly shown in FIG. 1;

FIG. 4 is an exploded perspective view a converter filter inductor of the multi-transformer assembly;

FIG. 5 is a perspective view of a housing of the converter filter inductor;

FIG. 6 is a cross-sectional perspective view of the converter filter inductor;

FIG. 7 is a perspective view of the converter filter inductor;

FIG. 8 is a side view of a portion of the converter filter inductor;

FIGS. 9 and 10 are perspective views of the housing of the converter filter inductor;

FIG. 11 is a top plan view of the converter filter inductor;

FIG. 12 is another perspective view of the converter filter inductor;

FIG. 13 top perspective view of the converter filter inductor;

FIG. 14 is a schematic diagram of a filter according to another example;

FIG. 15 is a perspective view of a multi-transformer assembly of another embodiment of the present disclosure;

FIG. 16 is a perspective view of a series of converter filter inductors of the multi-transformer assembly shown in FIG. 15;

FIG. 17 is a perspective view of a converter filter inductor shown in FIG. 16;

FIG. 18 is a cross-sectional view of the converter filter inductor shown in FIG. 16;

FIG. 19 is an exploded perspective view of the converter filter inductor;

FIG. 20 is a perspective view of a heatsink of the multi-transformer assembly, the heatsink including several converter filter inductor seats provided along an edge of the heatsink; and

FIG. 21 is a perspective view of a housing of the converter filter inductor.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Embodiments of the power module and the filter inductor may be described with reference to U.S. patent application Ser. No. 17/662,299, filed May 6, 2022, titled “Coupled Filter Inductor for Interleaved Power Converter,” which is hereby incorporated by reference in its entirety for any purpose.

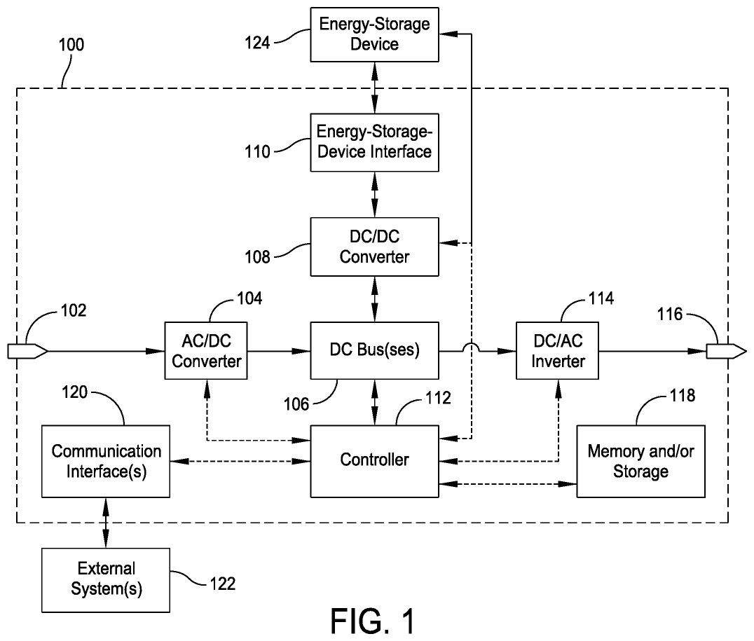

Filters are often employed in power devices, such as UPS s. FIG. 1 is a block diagram of a UPS 100 according to an example. In another example, FIG. 1 may illustrate a block diagram of one of several power modules of a UPS. The UPS 100 includes an input 102, an AC/DC converter 104, one or more DC busses 106, a DC/DC converter 108, an energy-storage-device interface 110, at least one controller 112 (“controller 112”), a DC/AC inverter 114, an output 116, a memory and/or storage 118, and one or more communication interfaces 120 (“communication interfaces 120”), which may be communicatively coupled to one or more external systems 122 (“external systems 122”).

The input 102 is coupled to the AC/DC converter 104 and to an AC power source (not pictured), such as an AC mains power supply. The AC/DC converter 104 is coupled to the input 102 and to the one or more DC busses 106, and is communicatively coupled to the controller 112. The one or more DC busses 106 are coupled to the AC/DC converter 104, the DC/DC converter 108, and to the DC/AC inverter 114, and are communicatively coupled to the controller 112. The DC/DC converter 108 is coupled to the one or more DC buses 106 and to the energy-storage-device interface 110, and is communicatively coupled to the controller 112. The energy-storage-device interface 110 is coupled to the DC/DC converter 108, and is configured to be coupled to at least one energy-storage device 124 and/or another energy-storage device.

In some examples, the energy-storage device 124 is external to the UPS 100 and coupled to the UPS 100 via the energy-storage-device interface 110. In various examples, the UPS 100 may include one or more energy-storage devices, which may include the energy-storage device 124. The energy-storage device 124 may include one or more batteries, capacitors, flywheels, or other energy-storage devices.

The DC/AC inverter 114 is coupled to the one or more DC buses 106 and to the output 116, and is communicatively coupled to the controller 112. The output 116 is coupled to the DC/AC inverter 114, and to an external load (not pictured). The controller 112 is communicatively coupled to the AC/DC converter 104, the one or more DC busses 106, the DC/DC converter 108, the energy-storage-device interface 110, the DC/AC inverter 114, the memory and/or storage 118, and the communication interfaces 120.

The input 102 is configured to be coupled to an AC mains power source and to receive input AC power having an input voltage level. The UPS 100 is configured to operate in different modes of operation based on the input voltage of the AC power provided to the input 102. The controller 112 may determine a mode of operation in which to operate the UPS 100 based on whether the input voltage of the AC power is acceptable. The controller 112 may include or be coupled to one or more sensors configured to sense parameters of the input voltage. For example, the controller 112 may include or be coupled to one or more sensors configured to sense a voltage level of the AC power received at the input 102.

When AC power provided to the input 102 is acceptable (for example, by having parameters, such as an input voltage value, that meet specified values, such as by falling within a range of acceptable input voltage values), the controller 112 controls components of the UPS 100 to operate in a normal mode of operation. In the normal mode of operation, AC power received at the input 102 is provided to the AC/DC converter 104. The AC/DC converter 104 converts the AC power into DC power and provides the DC power to the one or more DC buses 106. The one or more DC busses 106 distribute the DC power to the DC/DC converter 108 and to the DC/AC inverter 114. The DC/DC converter 108 converts the received DC power and provides the converted DC power to the energy-storage-device interface 110. The energy-storage-device interface 110 receives the converted DC power, and provides the converted DC power to the energy-storage device 124 to charge the energy-storage device 124. The DC/AC inverter 114 receives DC power from the one or more DC buses 106, converts the DC power into regulated AC power, and provides the regulated AC power to the output 116 to be delivered to a load.

When AC power provided to the input 102 from the AC mains power source is not acceptable (for example, by having parameters, such as an input voltage value, that do not meet specified values, such as by falling outside of a range of acceptable input voltage values), the controller 112 controls components of the UPS 100 to operate in a backup mode of operation. In the backup mode of operation, DC power is discharged from the energy-storage device 124 to the energy-storage-device interface 110, and the energy-storage-device interface 110 provides the discharged DC power to the DC/DC converter 108. The DC/DC converter 108 converts the received DC power and distributes the DC power amongst the one or more DC busses 106. For example, the DC/DC converter 108 may evenly distribute the power amongst the one or more DC busses 106. The one or more DC busses 106 provide the received power to the DC/AC inverter 114. The DC/AC inverter 114 receives the DC power from the one or more DC buses 106, converts the DC power into regulated AC power, and provides the regulated AC power to the output 116.

The controller 112 may store information in, and/or retrieve information from, the memory and/or storage 118. For example, the controller 112 may store information indicative of sensed parameters (for example, input-voltage values of the AC power received at the input 102) in the memory and/or storage 118. The controller 112 may further receive information from, or provide information to, the communication interfaces 120. The communication interfaces 120 may include one or more communication interfaces including, for example, user interfaces (such as display screens, touch-sensitive screens, keyboards, mice, track pads, dials, buttons, switches, sliders, light-emitting components such as light-emitting diodes, sound-emitting components such as speakers, buzzers, and so forth configured to output sound inside and/or outside of a frequency range audible to humans, and so forth), wired communication interfaces (such as wired ports), wireless communication interfaces (such as antennas), and so forth, configured to exchange information with one or more systems, such as the external systems 122, or other entities, such as human beings. The external systems 122 may include any device, component, module, and so forth, that is external to the UPS 100, such as a server, database, laptop computer, desktop computer, tablet computer, smartphone, central controller or data-aggregation system, other UPS s, and so forth.

In some examples, the UPS 100 may be a multi-phase UPS, such as a three-phase UPS. For example, the input 102 may include multiple inputs each configured to receive a respective phase line (and, in some examples, the multiple inputs may include a return input). Accordingly, although examples of FIG. 1 may be described with respect to a single connection and/or single-phase operation, it is to be appreciated that multi-phase operation is within the scope of FIG. 1 and the disclosure as a whole.

As discussed above, power converters may include and/or be coupled to filters. For example, one or more of the converters 104, 108, 114 may include, and/or be coupled to, one or more filters. The converters 104, 108, 114 may include one or more filtering components to, for example, reduce ripple current. In some examples, at least one of the converters 104, 108, 114 may be implemented with multiple interleaved converter legs in a single- or multi-phase system. For example, the UPS 100 may be a three-phase UPS and one or more of the converters 104, 108, 114 may include two or more interleaved power-conversion legs. For purposes of explanation, examples are provided in which one or more of the converters 104, 108, 114 includes two or more interleaved power-conversion legs.

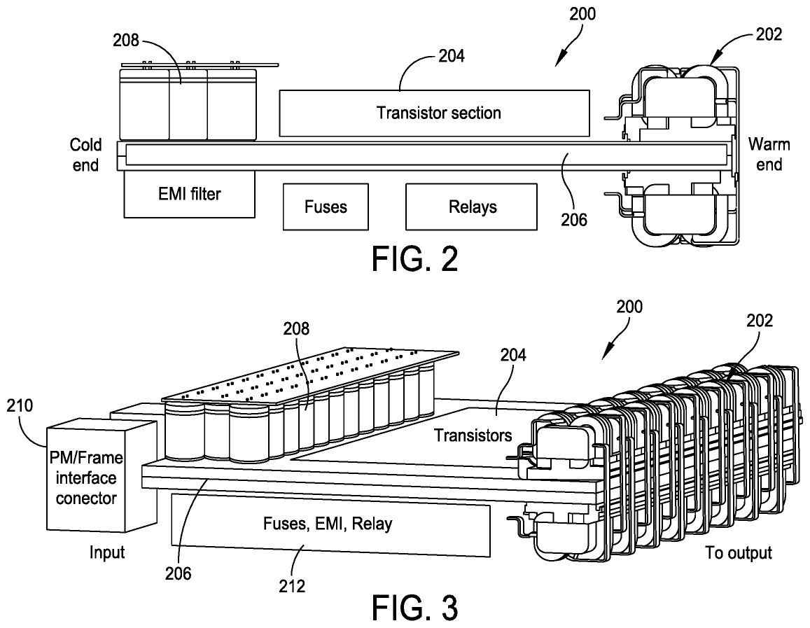

Referring to FIG. 2, a portion of a power module is generally indicated at 200. In some examples, the power module 200 may be a component of one or more of the converters 104, 108, 114. As shown, the power module 200 includes a converter filter inductor, generally indicated at 202, which is electrically located between a converter transistor section 204 and an output. The power module 200 further includes a heatsink 206, e.g., a liquid-cooled cold plate, at a center of the power module so that both sides of the heatsink can be utilized for cooling. To optimize the layout of the power module 200, it is desirable to be able to arrange various components on the heatsink 206 according to their cooling needs. To preserve the lifetime of the power module 200, direct-current capacitors, together indicated at 208, may be placed in the coldest section. For example, transistors of the transistor section 204, e.g., insulated-gate bipolar transistors, metal-oxide-semiconductor field-effect transistors, or silicon carbide transistors, produce considerable waste heat when in operation and cooling should be available for these components. Inductor chokes are made of materials that can withstand 200° C. without risk of component failure. That type of component may be placed on the warmest end of heatsink 206, near the converter filter inductor 202. Thus, the cooling circuit is optimized and, as a side benefit, the waste heat is further heated.

Electrically, embodiments of the power module 200 may be compact and, in some embodiments, short routing may be preferred for cost and power density. Referring to FIG. 3, incoming power travels from a power module/frame interface 210 through fuses and relays 212 on the underside of the heatsink 206. The converter filter inductor 202 is configured such that, apart from servicing the purpose of a filter inductor, it is simultaneously the connection between the underside and top side of the heatsink 206. On the top side of the heatsink 206, transistors of the transistor section 204 convert the power to direct-current (DC) power and either charge batteries or convert it back to alternating current (AC) output power. The converter filter inductor 202 may be duplicated as shown, e.g., eight times (8×) with three times (3×) input power, two times (2×) battery power, and three times (3×) output power. The provision of one or more converter filter inductors may be referred to herein as a multi-transformer assembly.

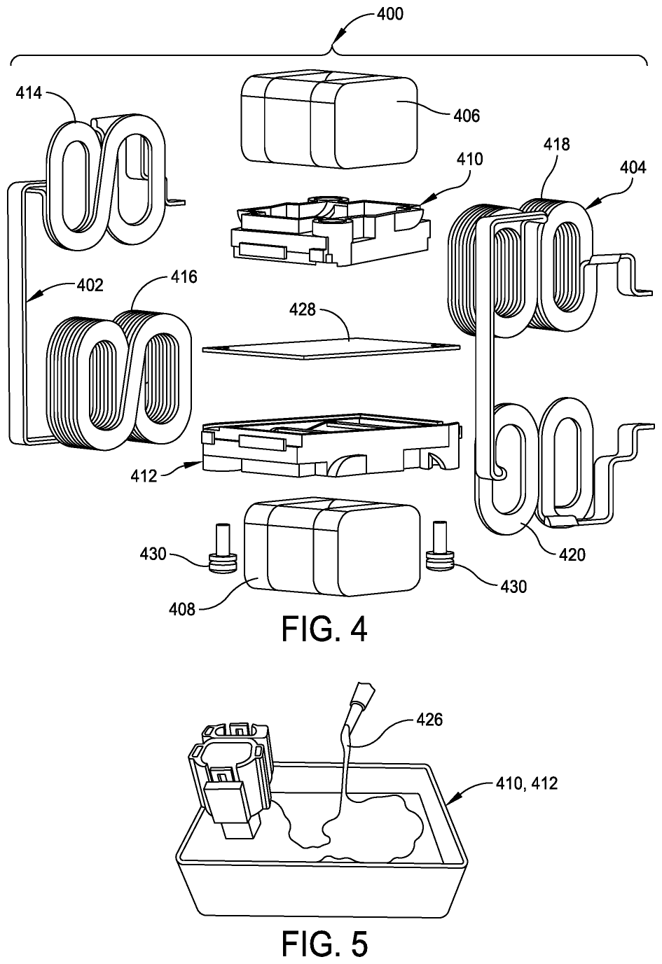

Referring to FIGS. 4 and 5, the components of a multi-transformer assembly, which is generally indicated at 400, are shown. As shown, the multi-transformer assembly 400 includes a first wound copper coil, generally indicated at 402, a second wound copper coil, generally indicated at 404, a first U-core (ferrite core) 406, a second U-core (ferrite core) 408, a first housing, generally indicated at 410, and a second housing generally indicated at 412.

In one embodiment, each wound copper coil 402, 404, can be fabricated from a copper strip, and bent to a desired shape. In the shown embodiment, the first wound copper coil 402 includes a first set of coil windings 414 having two turns on one core, e.g., the first core 406, and a second set of coil windings 416 having 16 turns on the other core, e.g., the second core 408. Similarly, the second wound copper coil 404 includes a first set of coil windings 418 having 16 turns on the one core, e.g., the first core 406, and a second set of coil windings 420 having two turns on the other core, e.g., the second core 408. It should be appreciated that the same configuration of the wound copper coil can be used for the first wound copper coil 402 and the second wound copper coil 404, with the coils being used in reversed.

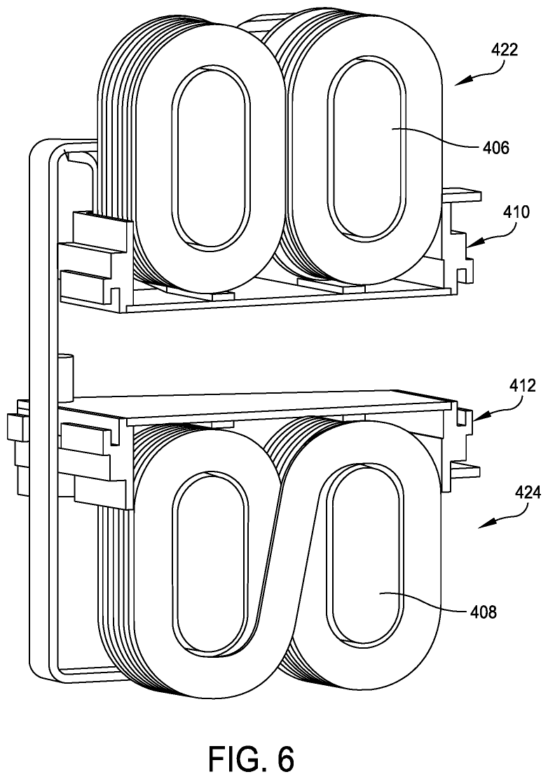

Referring additionally to FIG. 6, the arrangement is such that the first set of coil windings 414 from the first wound copper coil 402, the first set of coil windings 418 from the second wound copper coil 404, the first core 406 and the first housing 410 constitute a first transformer, generally indicated at 422, and the second set of coil windings 416 from the first wound copper coil 402, the second set of coil windings 420 from the second wound copper coil 404, the second core 408 and the second housing 412 constitute a second transformer, generally indicated at 424. In one embodiment, the first set of coil windings 414 of the first wound copper coil 402 of the first transformer 422 includes a first primary winding with N1 turns (e.g., two turns) and the first set of coil windings 418 of the second wound copper coil 404 of the first transformer 422 includes a first secondary winding with N2 turns (e.g., 16 turns), and the second set of coil windings 416 of the first wound copper coil 402 of the second transformer 424 includes a second primary winding with N3 turns (e.g., 16 turns) and the second set of coil windings 420 of the second wound copper coil 404 of the second transformer 424 includes a second secondary winding with N4 turns (e.g., two turns). Other configurations can be provided. For example, the number of turns may be altered to achieve a desired configuration.

Each of the first U-core 406 and the second U-core 408, is assembled with its respective first wound copper coil 402 and second wound copper coil 404 to form a rectangular shaped closed loop. As shown, each core 406, 408 is a solid core having circular ends. Other core shapes and sizes can be provided. The first housing 410 and the second housing 412 are provided to position the cores 406, 408 and hold potting material 426 (FIG. 5) used to secure the cores before the potting material cures or sets.

The multi-transformer assembly 400 further includes a heatsink 428 embodying a steel plate that acts as thermal bridge between the potting material 426 and the heatsink. A liquid cooling plate can be provided as the heatsink 428. The potting material 426 is poured into the plastic housing 410 or 412 in a liquid state until the potting material cures. Screw fasteners, each indicated at 430, are provided (e.g., four in total although two are shown) to secure the multi-transformer assembly 400 to the heatsink 428, and used to hold inside the potting material 426 during curing.

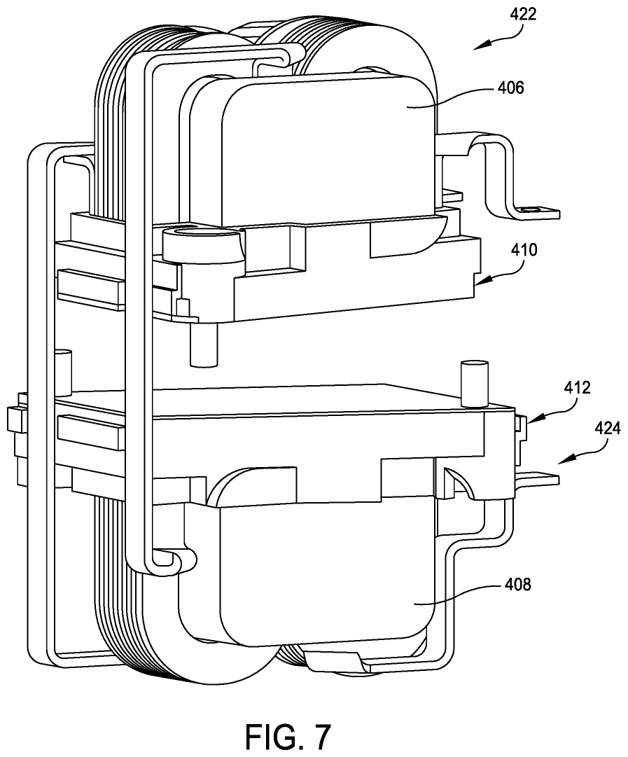

Referring additionally to FIG. 7, as mentioned above, the multi-transformer assembly 400 includes the first transformer 422 including the first core 406, the first set of coil windings 414 of the first wound copper coil 402, and the first set of coil windings 418 of the second wound copper coil 404. The multi-transformer assembly 400 further includes the second transformer 424 including the second core 408, the second set of coil windings 416 of the first wound copper coil 402, and the second set of coil windings 420 of the second wound copper coil 404. The multi-transformer assembly 400 further includes the heatsink 428, which is positioned between the first core 406 and the second core 408. The first housing 410 supports the first core 406 and the first sets of coil windings 414, 418 of the first wound copper coil 402 and the second wound copper coil 404, respectively, and the second housing 412 supports the second core 408 and the second sets of coil windings 416, 420 of the first wound copper coil 402 and the second wound copper coil 404, respectively. The potting material 426 is used to secure the cores 406, 408 in place with respect to the housings 410, 412. The screw fasteners 430 secure the housings 410, 412 to the heatsink 428.

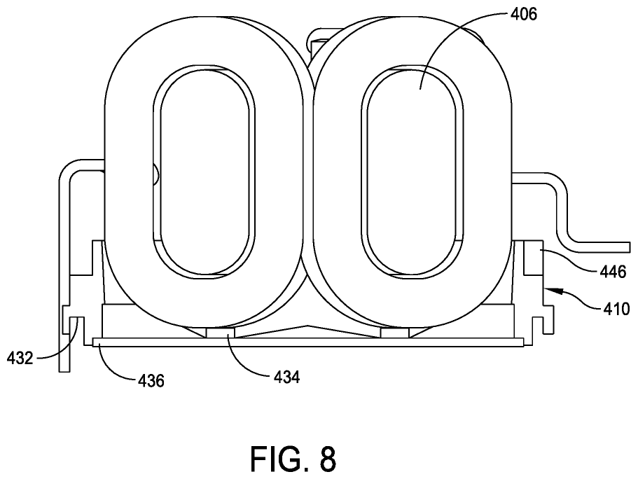

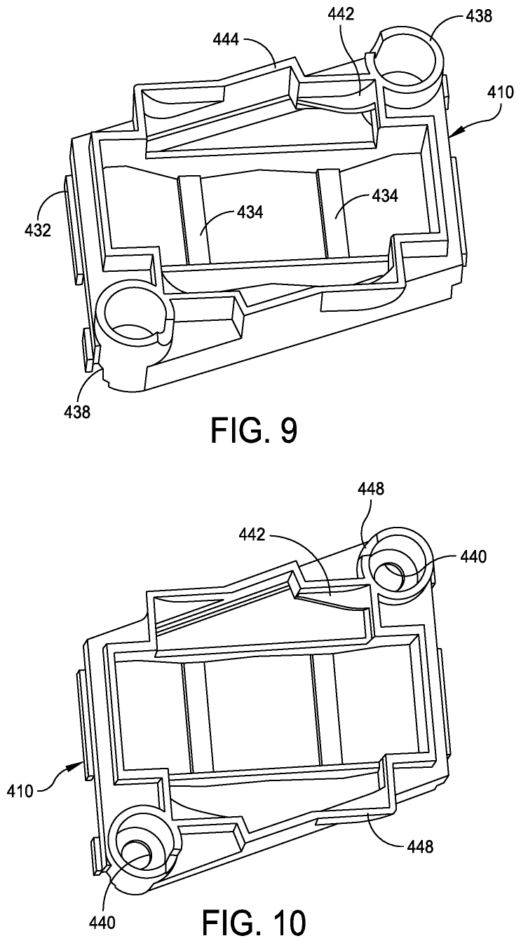

Referring additionally to FIGS. 8-10, in one embodiment, each of the first housing 410 and the second housing 412 includes a plastic housing body having several features built into the geometry of the housing for certain purposes. For example, as shown with respect to the first housing 410, the housing body includes a recess 432 to hold an additional piece of insulation (not shown) to electrically shield a copper strip of the wound copper coil 402 or 404 from the heatsink 428. The housing 410 further includes a plastic spacing 434 within the housing to secure minimum spacing between the heatsink 428 and the copper strip of the wound copper coil 402 or 404. The plastic spacing 434 is disposed adjacent to each wound copper coil 402, 404.

Each housing 410, 412 further includes a recess surface 436 (FIG. 8) that is configured to serve as gasket during the curing period for the potting material 426. Each housing 410, 412 further includes a recess structure 438 having an opening 440 formed therein to receive the screw fastener 430 to secure the housing to the heatsink 428. The recess structure 438 is arranged in such way that at least some creep and clearance spacing requirements are accommodated. Each housing 410, 412 further includes a position guide 442 for the core 406 or 408 and a pour point 444 for the potting material 426. The geometry of each housing 410, 412 is configured with a recess 446 to circumscribe the core 406 or 408 and wound copper coils 402, 404, so that the potting material 426 can be filled up to a predetermined level. Using thermally conductive potting material 426 may provide a solid thermal bridge to link from heat generating core 406, 408 and the wound copper coils 402, 404 to the heatsink 428. Each housing 410, 412 further includes a cutout and groove feature 448 that are arranged so that wound copper coils 402, 404 are lined-up side-by-side. With the cutout and groove feature 448, the multi-transformer assembly 400 can accommodate up to eight windings (chokes) on a total width of the filter, e.g., a total width of 508 millimeters (mm).

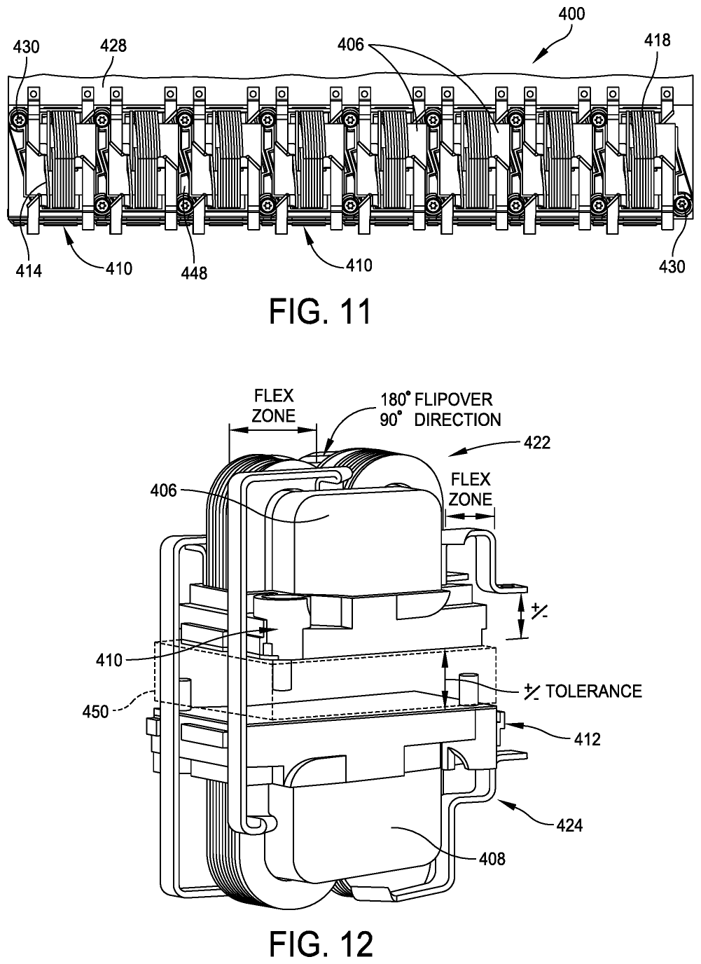

FIG. 11 illustrates the multi-transformer assembly 400 having multiple converter filter inductors. As shown, each multiple converter inductor includes a housing, e.g., first housing 410, configured to support the first core 406 and the first sets of coil windings 414, 418 of the first wound copper coil 402 and the second wound copper coil 404, respectively. Screw fasteners 430 are used to secure the first housings 410 to the heatsink 428.

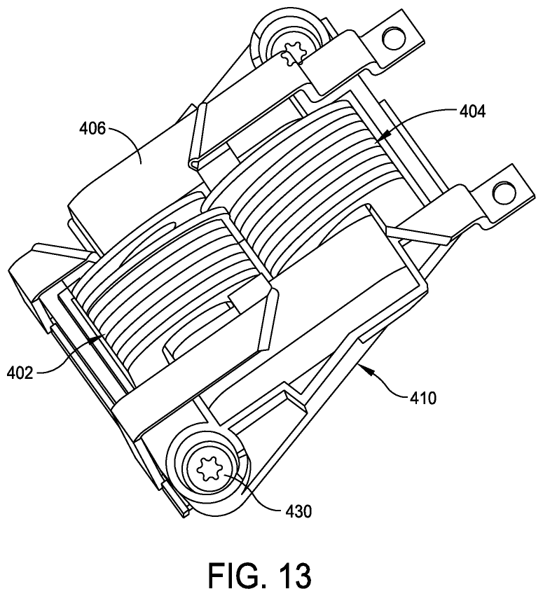

Referring to FIGS. 12 and 13, each of the first U-core 406 and the second U-core 408 has several features built into the geometry. For example, each of the first U-core 406 and the second U-core 408 includes flex-zones that are implemented with a 180° flip-over bend to make 90° direction change central for the function of the multi-transformer assembly. With the flex-zone, the copper strip is intentionally soft and thereby optimized to absorb +/−tolerances coming from thickness variations that may be a part of this type of construction. This may help avoid mechanical stresses in the copper strip putting the potting in mechanical stress, which could lead to fatigue related failures in the potting material. Each of the first U-core 406 and the second U-core 408 further includes two flex zones, a first flex zone to absorb +/−tolerances on the thickness of the cold plate and a second flex zone to absorb +/−tolerances in between the cold plate and the fixation points.

As shown, a jig 450 may be used to secure positions of the wound copper coils 402, 404 and the cores 406, 408 of the multi-transformer assembly 400 during curing of the potting material 426 and transport of the multi-transformer assembly. As shown, two wound copper coils 402, 404 may be wound around the two cores 406, 408, so that one serves as a dampening device for the other. The two wound copper coils 402, 404 may be arranged so that the coils enclose the end of the heatsink 428, e.g., the liquid-cooling cold plate. The two wound copper coils may be arranged so that the coils enclose the warmest end of the heatsink 428. The winding of the copper strip with flex zones may be implemented with two times (2×) 180° flip-over bend to make two times (2×) 90° direction bends in-between the windings on first core and the windings on the second core. There may be a recess to hold an additional piece of insulation. The recess and groove may allow about 8× chokes to be lined side by side in 508 mm total width.

Embodiments of a double choke construction for a power module, such as a liquid-cooled power module, reduce spare and wear parts, such as air fans and dust filters, make it possible to achieve closed construction that can be installed in “dirtier” environments, enables higher power density and operating temperatures to facilitate free cooling to help simplify and reduce cost, and produces waste heat that ideally is in 70-80° C. range.

Embodiments of the present disclosure increase the power density as well as address higher operating temperature and higher waste heat temperature.

In some embodiments, a multi-transformer assembly may include a first transformer including a first core and a first set of coil windings; a second transformer including a second core and a second set of coil windings; and a heatsink between the first core and the second core. The heatsink may include i) a first side thermally coupled to the first core and the first set of coil windings via a first thermal conductor and ii) a second side thermally coupled to the second core and the second set of coil windings via a second thermal conductor.

In some embodiments, two cores of two transformers may be located on opposite sides of a heatsink.

In some embodiments, the cores and the windings around them may be thermally coupled to heatsink using a thermal conductor (e.g., potting, plastic, gel, epoxy resin, thermal paste).

In some embodiments, cores and the windings around them may be thermally coupled to heatsink via metal plates. The thermal conductor may be placed between the cores/winding and the metal plates.

In some embodiments, the heatsink may be liquid-cooled. For example, a liquid may pass through the inside of the heatsink.

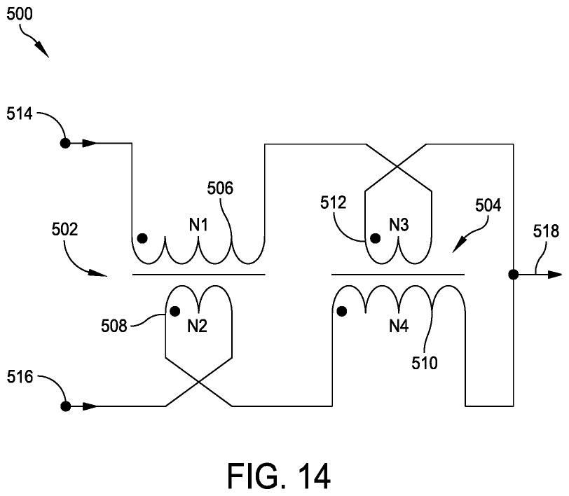

FIG. 14 illustrates a schematic diagram of a filter 500, which may embody at least a portion of the multi-transformer assembly disclosed herein. As shown, the filter 500 includes a first transformer 502 and a second transformer 504. The first transformer 502 includes a first primary winding 506 and a first secondary winding 508. The second transformer 504 includes a second primary winding 510 and a second secondary winding 512. The first primary winding 506 and the second secondary winding 512 may collectively represent an example of a first filtering component. The first secondary winding 508 and the second primary winding 510 may collectively represent an example of a second filtering component. The filter 500 further includes a first interleaved input 514, a second interleaved input 516, and an output 518.

The first primary winding 506 is coupled to the first interleaved input 514 at a dotted connection, and is coupled to the second secondary winding 512 at a non-dotted connection. In some examples, the first primary winding 506 is magnetically coupled to the first secondary winding 508. The first secondary winding 508 is coupled to the second interleaved input 516 at a non-dotted connection, and is coupled to the second primary winding 510 at a dotted connection. In some examples, the first secondary winding 508 is magnetically coupled to the first primary winding 506.

The second primary winding 510 is coupled to the first secondary winding 508 at a dotted connection, and is coupled to the output 518 at a non-dotted connection. In some examples, the second primary winding 510 is magnetically coupled to the second secondary winding 512. The second secondary winding 512 is coupled to the first primary winding 506 at a non-dotted connection, and is coupled to the output 518 at a dotted connection. In some examples, the second secondary winding 512 is magnetically coupled to the second primary winding 510.

The first interleaved input 514 is coupled to the first primary winding 506 and is configured to be coupled to a power converter. The second interleaved input 516 is coupled to the first secondary winding 508 and is configured to be coupled to a power converter. The output 518 is coupled to the second primary winding 510 and the second secondary winding 512, and is configured to be coupled to a power-converter output.

A first signal may be received at the first interleaved input 514 and provided to the first primary winding 506. The first signal may generate a magnetic field in the first primary winding 506, which may induce a current in the first secondary winding 508. The first primary winding 506 may provide the first signal to the second secondary winding 512. The first signal may generate a magnetic field in the second secondary winding 512, which may induce a current in the second primary winding 510. The second secondary winding 512 may provide the first signal to the output 518.

A second signal may be received at the second interleaved input 516 and provided to the first secondary winding 508. The second signal may generate a magnetic field in the first secondary winding 508, which may induce a current in the first primary winding 506. The first secondary winding 508 may provide the second signal to the second primary winding 510. The second signal may generate a magnetic field in the second primary winding 510, which may induce a current in the second secondary winding 512. The second primary winding 510 may provide the second signal to the output 518.

In various examples, the transformers 502, 504 present an impedance to the first and/or second signals depending at least in part on a number of windings of the transformers 502, 504. The first primary winding 506 has N1 windings, the first secondary winding 508 has N2 windings, the second primary winding 510 has N4 windings, and the second secondary winding 512 has N3 windings. In at least one example, N1 is approximately equal to N4, and N2 is approximately equal to N3. An impedance presented by the transformers 502, 504 may also depend at least in part on a frequency of signals received by the transformers 502, 504.

Signals received at the PWM frequency arrive at the filter 500 in opposite phases due to the interleaving of the power converters. The magnetic fields generated by opposite-phase currents in the transformers 502, 504 may add with one another. The inductance presented to the signals by the first transformer 502 may be equal to (N1+N2)²*A_{L}, where A_{L} is the specific inductance for a single turn for a used magnetic core of the windings 506, 508. In some examples, each of the turns of the windings 506, 508 may have the same specific inductance A_{L}. In other examples, the turns may have different specific inductances (for example, resulting from manufacturing differences), and A_{L} may represent an average specific inductance of the turns. The inductance presented to the signals by the second transformer 504 may be equal to (N3+N4)²*A_{L}, where A_{L} is the specific inductance for a single turn for a used magnetic core of the windings 510, 512. In some examples, each of the turns of the windings 510, 512 may have the same specific inductance A_{L}. In other examples, the turns may have different specific inductances (for example, resulting from manufacturing differences), and A_{L} may represent an average specific inductance of the turns.

Signals received at the load-current frequency or other non-interleaved frequencies may arrive at the filter 500 in phase with one another. The magnetic fields generated by the in-phase currents in the transformers 502, 504 may oppose one another. The inductance presented to the signals by the first transformer 502 may be equal to (N1−N2)²*A_{L}, where A_{L} is the specific inductance for a single turn for a used magnetic core of the windings 506, 508. In some examples, each of the turns of the windings 506, 508 may have the same specific inductance A_{L}. In other examples, the turns may have different specific inductances (for example, resulting from manufacturing differences), and A_{L} may represent an average specific inductance of the turns. The inductance presented to the signals by the second transformer 504 may be equal to (N4−N3)²*A_{L}, where A_{L} is the specific inductance for a single turn for a used magnetic core of the windings 510, 512. In some examples, each of the turns of the windings 510, 512 may have the same specific inductance A_{L}. In other examples, the turns may have different specific inductances (for example, resulting from manufacturing differences), and A_{L} may represent an average specific inductance of the turns.

Accordingly, the transformers 502, 504 may present a different inductance (and, thus, a different impedance) to in-phase currents, such as signals at the load frequency, as opposed to out-of-phase currents, such as signals at the PWM frequency. An effective number of turns seen by in-phase currents, such as the load current, may be proportional to a difference (for example, a squared difference) between the number of primary and secondary windings of each of the transformers 502, 504. An effective number of turns seen by out-of-phase currents, such as signals at the PWM frequency, may be proportional to a sum (for example, a squared sum) of the number of primary and secondary windings of each of the transformers 502, 504. A magnetic field generated by in-phase currents may be reduced by the same factor by which the effective inductance is reduced (relative to, for example, other filters having the same number of turns but a different arrangement, such as the filter 300), which may allow a higher-core-permeability material to be used as a core material for the transformers 502, 504 without substantially changing a total relative core saturation.

Accordingly, examples provided herein improve power-converter filtering at least in part by reducing ripple current while improving a dynamic response to load-step currents. In various examples, the transformers 502, 504 may be designed to be substantially similar or identical components, thereby reducing a complexity of the filter 500. A number of windings of the transformers 502, 504 may be selected based on design requirements of the filter 500 and, in various examples, the transformers 502, 504 may include low-cost and/or low-complexity core materials. The filter 500 may therefore be reduced in size, cost, and/or complexity compared to some existing solutions.

As discussed above, N1, N2, N3, and N4 may be selected based on one or more design requirements. In at least one example, a turns ratio (N1:N2) of the first transformer 502 may be based on a turns ratio (N4:N3) of the second transformer 504. For example, the turns ratio of the first transformer 502 may be equal to, or approximately equal to, or within a threshold amount of, the turns ratio of the second transformer 504. In some examples, N1 may be configured to be within a certain number of turns of N4. For example, N1 may be configured to be within 12 turns of N4. Continuing with this example, if N1 has 35 turns, then N4 may have between 23 and 47 turns. In other examples, N1 may be configured to have a number of turns that is within a certain percentage of a number of turns of N4. For example, N1 may be configured to have a number of turns that is within 20% of a number of turns of N4. Continuing with this example, if N1 has 35 turns, then N4 may have between 28 and 42 turns, that is, within seven turns of 35 turns.

Similarly, in various examples, N2 may be configured to be within a certain number of turns of N3. For example, N2 may be configured to be within two turns of N3. Continuing with this example, if N2 has seven turns, then N3 may have between five and nine turns. In other examples, N2 may be configured to have a number of turns that is within a certain percentage of a number of turns of N3. For example, N2 may be configured to have a number of turns that is within 20% of a number of turns of N3. Continuing with this example, if N2 has seven turns, then N3 may have between six and eight turns, that is, within 1.4 turns of seven turns.

In one example, a ratio of N1:N2 and of N4:N3 is between 4:1 and 6:1. In one example, N1 and N4 are each approximately 35, and N2 and N3 are each approximately seven. Accordingly, in one example, N1 is equal to N4, N2 is equal to N3, and N1:N2 is 35:7.

As discussed above, the optional output filter 210 may include one or more filtering components. In one example, the optional output filter 210 includes one or more capacitors. For example, the optional output filter 210 may include one or more capacitors presenting a capacitance of 40 μF to signals originating from each of the second primary winding 510 and the second secondary winding 512. In some examples, a capacitance may depend in part on N1, N2, N3, N4, and A_{L}. In some examples, A_{L} may be approximately 138 nH.

In various examples, components of the power converter 200 may be added, removed, and/or rearranged where the power converter 200 is bi-directional. For example, the power converter 200 may include additional filters between the interleaved power converters 212 and the input 202, and/or may include one or more bypass switches to route signals as needed or desired.

Various controllers, such as the controller 112, may execute various operations discussed above. For example, as discussed above, the controller 112 may control switching operation of the converters 104, 108, 114, amongst other operations. Using data stored in associated memory and/or storage, the controller 112 may execute one or more instructions stored on one or more non-transitory computer-readable media, which the controller 112 may include and/or be coupled to, that may result in manipulated data. In some examples, the controller 112 may include one or more processors or other types of controllers. In one example, the controller 112 is or includes at least one processor. In another example, the controller 112 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

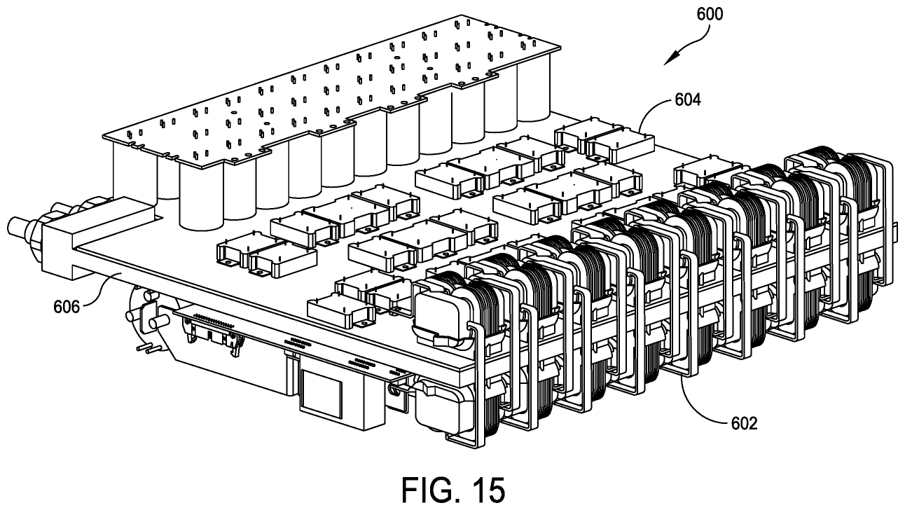

In another embodiment, with reference to FIG. 15, a power module is generally indicated at 600. As shown, the power module 600 includes a series of converter filter inductors, together indicated at 602, which are electrically located between a converter transistor section 604 and an output. The power module 600 further includes a heatsink 606, e.g., a liquid-cooled cold plate, at a center of the power module so that both sides of the heatsink can be utilized for cooling. To optimize the layout of the power module 600, it is desirable to be able to arrange various components on the heatsink 606 according to their cooling needs. Similar to power module 200, to preserve the lifetime of the power module 600, direct-current capacitors may be placed in the coldest section. The cooling circuit can be optimized and, as a side benefit, the waste heat can be further heated.

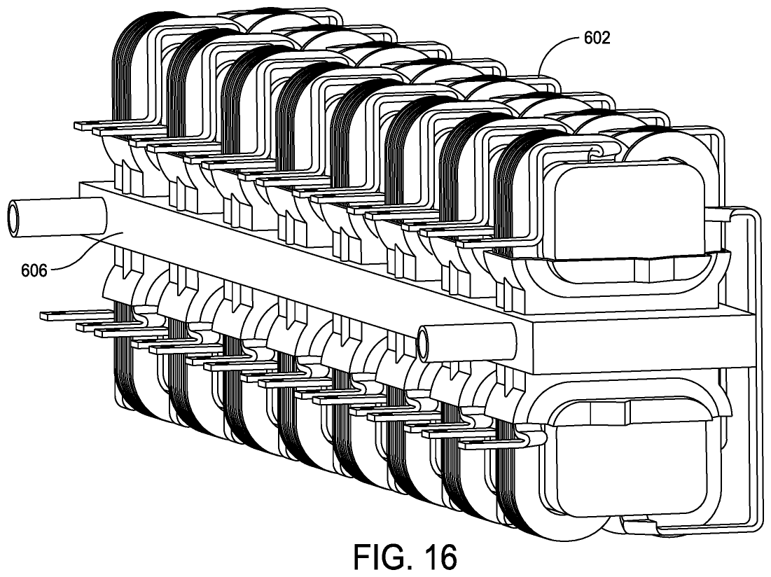

Electrically, embodiments of the power module 600 may be compact and, in some embodiments, short routing may be preferred for cost and power density. Incoming power travels from a power module/frame interface through fuses and relays on the underside of the heatsink. Referring additionally to FIG. 16, the converter filter inductors 602 are configured such that, apart from servicing the purpose of a filter inductor, they are simultaneously the connection between the underside and top side of the heatsink 606. On the top side of the heatsink 606, transistors of the transistor section 604 convert the power to direct-current (DC) power and either charge batteries or convert it back to alternating current (AC) output power. The converter filter inductors 602 may be duplicated as shown, e.g., eight times (8×), with three times (3×) input power, two times (2×) battery power, and three times (3×) output power. The provision of one or more converter filter inductors 602 may be referred to herein as a multi-transformer assembly.

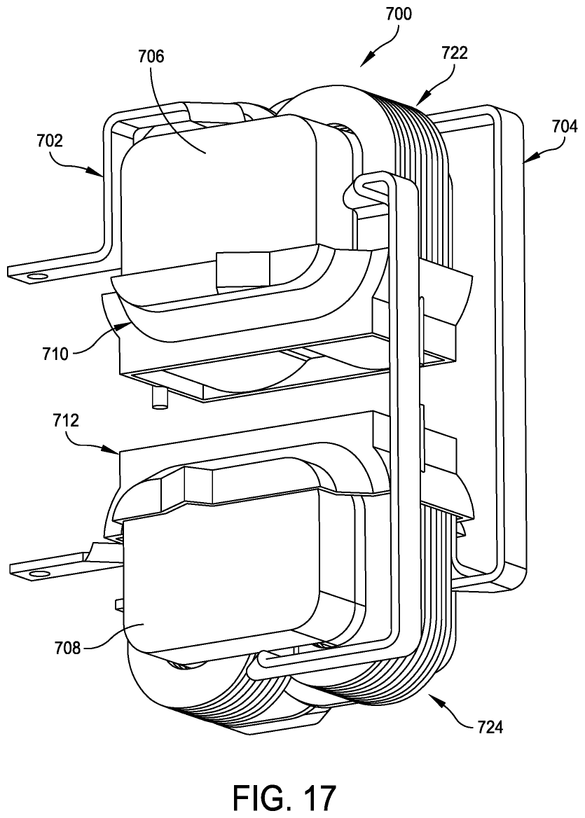

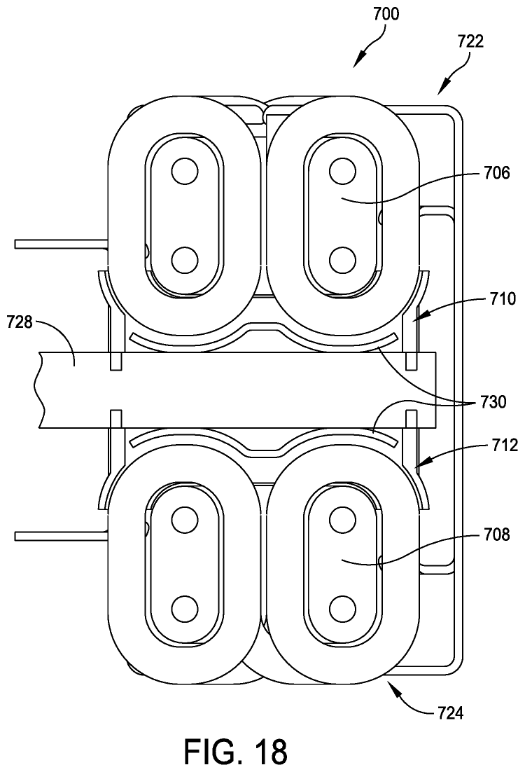

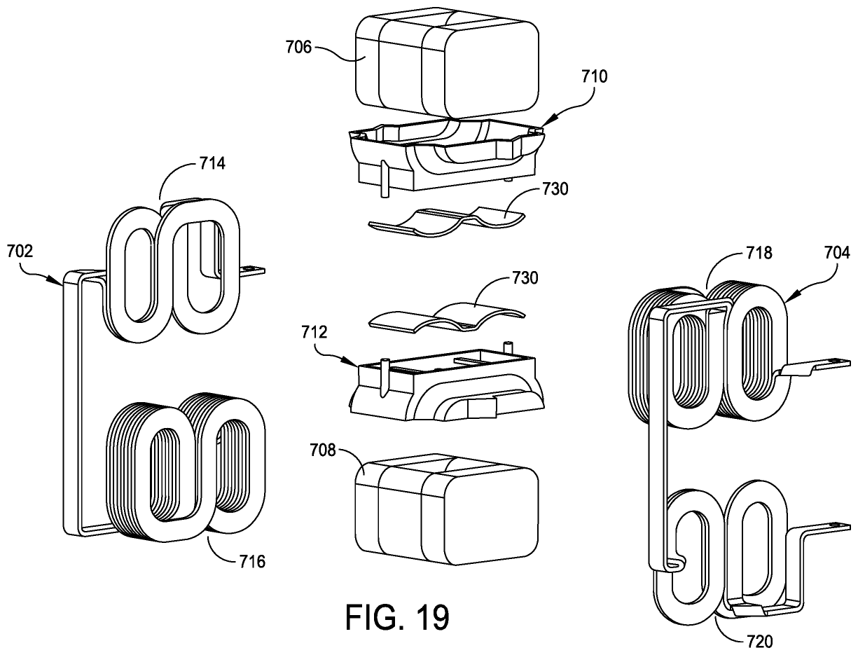

Referring to FIGS. 17 and 18, the components of a converter filter inductor, also referred to as a multi-transformer assembly, which is generally indicated at 700, are shown. As shown, the multi-transformer assembly 700 includes a first wound copper coil, generally indicated at 702, a second wound copper coil, generally indicated at 704, a first U-core (ferrite core) 706, a second U-core (ferrite core) 708, a first housing, generally indicated at 710, and a second housing generally indicated at 712. In one embodiment, each wound copper coil 706, 708, can be fabricated from a copper strip, and bent to a desired shape. In the shown embodiment, with additional reference to FIG. 19, the first wound copper coil 702 includes a first set of coil windings 714 having two turns on one core, e.g., the first core 706, and a second set of coil windings 716 having 16 turns on the other core, e.g., the second core 708. Similarly, the second wound copper coil 704 includes a first set of coil windings 718 having 16 turns on the one core, e.g., the first core 706, and a second set of coil windings 720 having two turns on the other core, e.g., the second core 720. It should be appreciated that the same configuration of the wound copper coil can be used for the first wound copper coil 702 and the second wound copper coil 704, with the coils being used in reversed.

The arrangement is such that the first set of coil windings 714 from the first wound copper coil 702, the first set of coil windings 718 from the second wound copper coil 704, the first core 706 and the first housing 710 constitute a first transformer, generally indicated at 722, and the second set of coil windings 716 from the first wound copper coil 702, the second set of coil windings 720 from the second wound copper coil 704, the second core 708 and the second housing 712 constitute a second transformer, generally indicated at 724. In one embodiment, the first set of coil windings 714 of the first wound copper coil 702 of the first transformer 722 includes a first primary winding with N1 turns (e.g., two turns) and the first set of coil windings 718 of the second wound copper coil 704 of the first transformer 722 includes a first secondary winding with N2 turns (e.g., 16 turns), and the second set of coil windings 716 of the first wound copper coil 702 of the second transformer 724 includes a second primary winding with N3 turns (e.g., 16 turns) and the second set of coil windings 720 of the second wound copper coil 704 of the second transformer 724 includes a second secondary winding with N4 turns (e.g., two turns). Other configurations can be provided. For example, the number of turns may be altered to achieve a desired configuration.

Each of the first U-core 706 and the second U-core 708, is assembled with its respective first wound copper coil 702 and second wound copper coil 704 to form a rectangular shaped closed loop. As shown, each core 706, 708 is a solid core having circular ends. Other core shapes and sizes can be provided. The first housing 710 and the second housing 712 are provided to position the cores 706, 708 and hold potting material used to secure the cores before the potting material cures or sets.

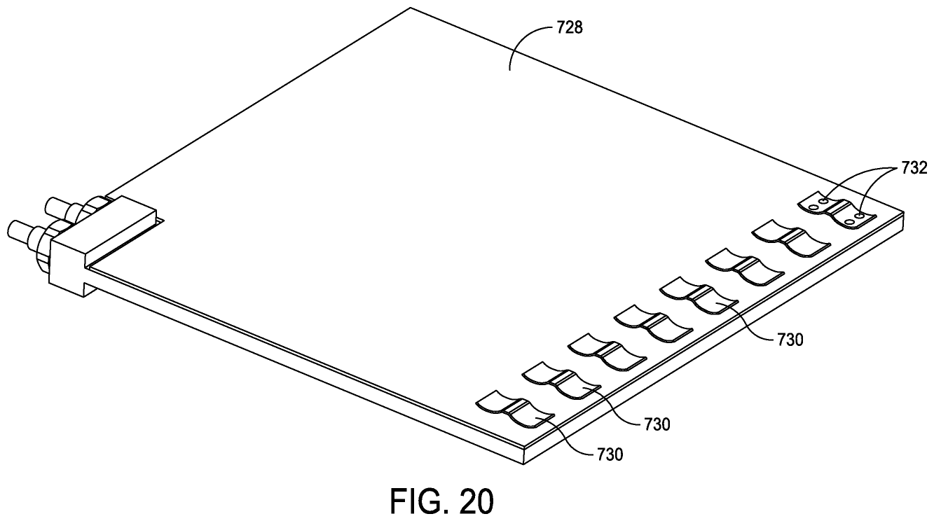

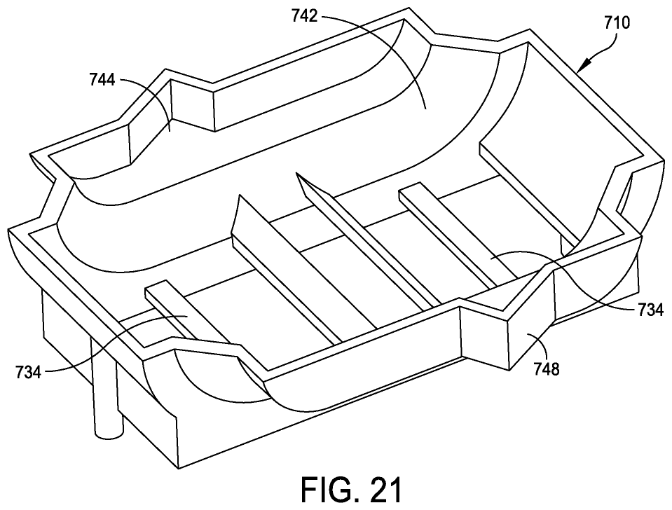

The multi-transformer assembly 700 further includes a heatsink 728 embodying a steel plate that acts as thermal bridge between the potting material and the heatsink. A liquid cooling plate can be provided as the heatsink 728. As with multi-transformer assembly 400, the potting material is poured into the plastic housing 710, 712 in a liquid state until the potting material cures. In place of screw fasteners, the multi-transformer assembly 700 further includes two thermal seats, each indicated at 730, which are welded to the heatsink 728 on opposite sides of the heatsink and glued or adhered to their respective housing 710, 712. Referring additionally to FIG. 20, the heatsink 728 includes a row of thermal seats 730 arranged along an edge of the heatsink. The thermal seats 730 are provided to position the filter inductors with respect to one another and to provide a thermal bridge between the heatsink 728 and the coil windings.

In one embodiment, each thermal seat 730 may be fabricated from a thermally transmissive material, e.g., aluminum. Each thermal seat 730 may be shaped to maximize the thermal transfer from the windings of its respective transformer 722, 724 to the heatsink 728. For example, each thermal seat 730 may be secured to the heatsink 728 by a suitable metal joining process, such as welding, brazing or soldering. In another method, each thermal seat 730 may be secured to the heatsink 728 by using heat, such as a resistant welding process.

In one embodiment, each thermal seat 730 may be secured to its respective housing 710 or 712 by a suitable adhesive process, e.g., by gluing the housing to the thermal seat. In one method, the housing 710 or 712 may be secured to its respective thermal seat 730 by an epoxy gap filler.

Referring additionally to FIG. 21, in one embodiment, each of the first housing 710 and the second housing 712 includes a plastic housing body having several features built into the geometry of the housing for certain purposes. For example, as shown with respect to the first housing 710, the housing body includes a plastic spacing 734 within the housing to secure minimum spacing between the thermal seat of the heatsink 728 and the copper strip of the wound copper coil 702 or 704. The plastic spacing 734 is disposed adjacent to each wound copper coil. The housing 710 further includes a position guide 742 for the core 706 or 708 and a pour point 744 for the potting material. The housing 710 further includes a cutout and groove feature 748 that are arranged so that wound copper coils 702, 704 are lined-up side-by-side. With the cutout and groove feature 748, the multi-transformer assembly 700 can accommodate up to eight windings (chokes) to achieve a desired total width.

Clamps may be used to secure positions housings 710, 712 to the thermal seats 730 of the heatsink 728.

As discussed above with respect to FIG. 1, the UPS 100 may include several converters 104, 108, 114, any of which may include a power module such as the power module 200. In other examples, a power system (for example, a UPS, a battery energy storage system [BESS], a fuel-cell system, a hydrogen generation system [HGS], and/or another type of power system) may differ from the topology of the UPS 100 but may similarly include at least one converter implementing a power module such as the power module 200.

For example, an example power system may be substantially similar to the UPS 100 but may not include the DC busses 106, the DC/DC converter 108, the energy-storage-device interface 110, and the DC/AC inverter 114, and may not be coupled to the energy-storage device 124. In this example, an output of the AC/DC converter 104 may be connected directly to the output 116 rather than being coupled to the DC/DC converter 108 and the DC/AC inverter 114 via the DC busses 106. The power system may therefore output, via the AC/DC converter 104, DC current to the output 116. Such a power system may be implemented in connection with an HGS, systems with DC-powered loads (for example, a data center with DC-powered server racks), and so forth.

In another example, an example power system may be substantially similar to the UPS 100 but may not include the DC/AC inverter 114 or the output 116. In this example, an output of the AC/DC converter 104 may be connected only to the DC/DC converter 108 via the DC busses 106, rather than also being connected to the DC/AC inverter 114 via the DC busses 106. The power system may therefore output, via the AC/DC converter 104, DC current to the energy-storage device 124 via the energy-storage-device interface 110. In some examples, the system may be bidirectional such that the power system also receives DC power from the energy-storage device 124 via the energy-storage-device interface 110. Such a power system may be implemented in connection with a BESS, for example, to control energy levels of one or more batteries.

In another example, an example power system may be substantially similar to the UPS 100 but may not include the AC/DC converter 104, the DC/AC inverter 114, and the output 116. In this example, the input 102 may receive DC power and may be connected to the DC/DC converter 108. This example may therefore be similar to the immediately preceding example; however, rather than receiving AC power at the input 102 which is rectified to DC power to provide to the DC/DC converter 108, DC power is received at the input 102 and provided to the DC/DC converter 108. Such a power system may also be implemented with a BESS, for example, where DC power is received instead of AC power.

In other examples, other topologies may be implemented with power converters that include power modules such as the power module 200. Accordingly, the foregoing examples of power converters are provided for purposes of example rather than limitation.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A multi-transformer assembly, comprising:
a first transformer comprising a first core and a first set of windings;
a second transformer comprising a second core and a second set of windings; and
a heatsink positioned between the first core and the second core.

2. The multi-transformer assembly of claim 1, wherein the heatsink includes a first side and a second side.

3. The multi-transformer assembly of claim 2, wherein the first side of the heatsink is opposite the second side of the heatsink.

4. The multi-transformer assembly of claim 2, wherein the first side is thermally coupled to the first core and the first set of windings.

5. The multi-transformer assembly of claim 4, wherein the first side is thermally coupled to the first core and the first set of windings by a first thermal conductor.

6. The multi-transformer assembly of claim 2, wherein the second side is thermally coupled to the second core and the second set of windings.

7. The multi-transformer assembly of claim 6, wherein the second side is thermally coupled to the second core and the second set of windings by a second thermal conductor.

8. The multi-transformer assembly of claim 4, wherein the second side is thermally coupled to the second core and the second set of windings.

9. The multi-transformer assembly of claim 8, wherein the second side is thermally coupled to the second core and the second set of windings by a second thermal conductor.

10. The multi-transformer assembly of claim 1, wherein the first set of windings of the first transformer includes a first primary winding with N1 turns and a first secondary winding with N2 turns, and the second set of windings of the second transformer includes a second primary winding with N4 turns and a second secondary winding with N3 turns.

11. The multi-transformer assembly of claim 10, wherein the first primary winding and the second secondary winding are in series with a first input and an output, and the first secondary winding and the second primary winding are in series with a second input and the output.

12. The multi-transformer assembly of claim 11, wherein the first primary winding and the first secondary winding are configured to generate in-phase magnetic fields that cancel each other responsive to receiving at least one signal from at least one of the first input or the second input, and wherein the second primary winding and the second secondary winding are configured to generate in-phase magnetic fields that cancel each other responsive to receiving the at least one signal from the at least one of the first input or the second input.

13. The multi-transformer assembly of claim 12, wherein a turns ratio of the first transformer is based on a turns ratio of the second transformer.

14. The multi-transformer assembly of claim 1, wherein the heatsink includes at least one plate.

15. The multi-transformer assembly of claim 1, wherein the first core of the first transformer and the second core of the second transformer each include a ferrite core.

16. The multi-transformer assembly of claim 1, further comprising a first housing configured to support the first set of windings and the first core of the first transformer and a second housing configured to support the second set of windings and the second core of the second transformer.

17. The multi-transformer assembly of claim 16, wherein each of the first housing and the second housing are configured to receive a thermal coupling material to secure the first core and the first set of windings of the first transformer to a first side of the heatsink and to secure the second core and the second set of windings of the second transformer to a second side of the heatsink.

18. The multi-transformer assembly of claim 16, wherein the first housing includes a first guide to position the first core to the first housing and the second housing includes a second guide to position the second core to the second housing.

19. A method of assembling a multi-transformer assembly, the method comprising:
providing a heatsink having a first side and a second side;
thermally coupling a first core and a first set of windings of a first transformer to the first side of the heatsink; and
thermally coupling a second core and a second set of windings of a second transformer to the second side of the heatsink.

20. The method of claim 19, wherein the first side is thermally coupled to the first core and the first set of windings by a first thermal conductor and the second side is thermally coupled to the second core and the second set of windings by a second thermal conductor.

21. The method of claim 19, wherein the first side of the heatsink is opposite the second side of the heatsink.

22. The method of claim 19, wherein at least one of
the first transformer is configured to generate in-phase magnetic fields that cancel each other, or
the second transformer is configured to generate in-phase magnetic fields that cancel each other.

23. The method of claim 19, wherein the first transformer includes a first primary winding and a first secondary winding, and wherein the first primary winding and the first secondary winding are configured to generate in-phase magnetic fields to cancel each other out responsive to the first primary winding and the first secondary winding each receiving a respective signal.

24. The method of claim 23, wherein the second transformer includes a second primary winding coupled to the first secondary winding and a second secondary winding coupled to the first primary winding, and wherein the second primary winding and the second secondary winding are configured to generate in-phase magnetic fields to cancel each other out responsive to the second primary winding and the second secondary winding each receiving a respective signal.

25. The method of claim 19, wherein the second transformer includes a primary winding and a secondary winding, and wherein the primary winding and the secondary winding are configured to generate in-phase magnetic fields to cancel each other out responsive to the primary winding and the secondary winding each receiving a respective signal.

26. The method of claim 19, further comprising securing the first core and the first set of windings of the first transformer to a first housing and securing the second core and the second set of windings of the second transformer to a second housing.

27. The method of claim 26, wherein a thermal coupling material is used to secure the first set of windings and the first core of the first transformer to the first housing and to secure the second set of windings and the second core of the second transformer to the second housing.

28. A method for providing a choke to a power module, the method comprising:
receiving, at a first input, a first signal;
providing the first signal to a first primary winding of a first transformer including the first primary winding and a first secondary winding;
providing the first signal from the first primary winding to a second secondary winding of a second transformer comprising a second primary winding and the second secondary winding;
providing the first signal from the second secondary winding to an output;
receiving, at a second input, a second signal;
providing the second signal to the first secondary winding;
providing the second signal from the first secondary winding to the second primary winding; and
providing the second signal from the second primary winding to the output,
wherein a heatsink is positioned between a first core and a second core, the heatsink including a first side and a second side, the first side being thermally coupled to the first core and a first set of windings by a first thermal conductor and the second side being thermally coupled to the second core and a second set of windings by a second thermal conductor.
